(19) United States
(12) Patent Application Publication
(10) Pub. No.: US 2018/0333957 A1
(43) Pub. Date: Nov. 22, 2018

(54) METHOD AND CLEANER FOR CLEANING A PRINTER OF A PRINTING SYSTEM, AND A CORRESPONDING PRINTING SYSTEM

(71) Applicant: Océ Holding B.V., Venlo (NL)

(72) Inventors: Kay Luecke, Fuerstenfeldbruck (DE); Admir Lela, Haar (DE); Oliver Eck, Finsing (DE)

(73) Assignee: Océ Holding B.V., Venlo (NL)

(21) Appl. No.: 15/981,074

(22) Filed: May 16, 2018

(30) Foreign Application Priority Data
May 16, 2017 (DE) 10 2017 110574.3

(51) Int. Cl. B41J 2/165

(52) U.S. Cl. CPC B41J 2/16552; B41J 2002/1655; B41J 2/16535

(57) ABSTRACT

In a method to clean a printer of a printing system (e.g. an inkjet printing system), at least one displaceable cleaning nozzle is arranged in a self-cleaning position, a pressure-charged cleaning agent is supplied to self-clean the cleaning nozzle, the cleaning nozzle is displaced into a spraying position for spraying the printer, and the printer is sprayed with cleaning agent. A cleaner for automatic cleaning of a printer of a printing system, as well as a corresponding printing system can perform the clean method.

### CROSS REFERENCE TO RELATED APPLICATIONS

This patent application claims priority to German Patent Application No. 102017110574.3, filed May 16, 2017, which is incorporated herein by reference in its entirety.

### BACKGROUND

In inkjet printing, a multicolor, no-contact, direct printing takes place that is based on thermal or electrophysical principles. Ink droplets in liquid form are thereby fired from print heads, starting from the nozzle surfaces, onto the print medium. For example, this is explained in the publication DE 102 33 409 A1.

Numerous measures exist for quality improvement in inkjet printing. The regular cleaning of the print heads or their nozzle face represents such a measure.

In particular given multicolor inkjet printers, multiple print bars for different inks are normally provided, wherein a print bar is provided with one or more respective print heads. The different inks may have various ink structures (base, dye, base pigment, base polymer), whereby the nozzle faces of the print heads of the different print bars are soiled at different rates and severities. The different ink structures can thus be cleaned off of the nozzle face more or less easily. Nozzles firing at an angle, or even nozzles that are entirely clogged, may occur due to ink residues on the nozzle faces of the print heads. Such disruptions lead to unwanted streaks in the print image, and thus negatively affect the print quality.

In order to clean the print heads of ink residues, an automatic print head cleaning by purging and wiping is performed in defined cycles.

What is known as purging comprises a brief, strong output of ink through all print nozzles of a print head, what is known as shooting through. A kind of through-flushing effect is thus created that releases possible residues from the print nozzles. What is known as wiping comprises a wiping of the nozzle face with a wiping lip. This is described in EP 1 445 104 B1, for example.

However, too frequent purging/wiping may be problematic. The nozzle plate or nozzle face normally has a coating, in particular an anti-adhesion coating, which may wear due to the mechanical stress of the wiping.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a flowchart of a method according to an exemplary embodiment of the present disclosure;

FIG. 2A-D illustrate various states of a cleaner in the workflow of a method according to FIG. 1;

FIG. 2E illustrates a cleaning step (e.g. purging) according to an exemplary embodiment of the present disclosure;

FIG. 2F illustrates a cleaning step (e.g. wiping) according to an exemplary embodiment of the present disclosure;

FIG. 3 illustrates a schematic diagram of a fluid system of a cleaner according to an exemplary embodiment of the present disclosure;

FIG. 4 illustrates a schematic depiction of a section of a printing system according to an exemplary embodiment of the present disclosure; and

FIG. 5 illustrates a schematic depiction of a print bar of a printer according to an exemplary embodiment of the present disclosure.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The disclosure relates to a method for cleaning a printer of a printing system (e.g. an inkjet printing system); a cleaner configured to automatic clean a printer of a printing system (e.g. an inkjet printing system); and a corresponding printing system (e.g. an inkjet printing system). Although exemplary embodiments are described with respect to inkjet printing, the present disclosure is not limited to inkjet printing technologies and is applicable to other printing technologies as would be understood by one of ordinary skill in the art.

An object of the present disclosure is to provide an improved method and an improved cleaner for cleaning a print head.

The disclosure relates to a method for cleaning a printer of a printing system, in particular of an inkjet printing system, with the following steps: arrange at least one displaceable cleaning nozzle in a self-cleaning position; self-cleaning of the cleaning nozzle via pressure-charged supply of cleaning agent; displacement of the cleaning nozzle into a spraying position to spray the printer; and spraying of the printer with cleaning agent.

The disclosure also relates to a cleaner configured to automatic clean a printer of a printing system, such as an inkjet printing system. In an exemplary embodiment, cleaner includes at least one displaceable cleaning nozzle; a protected section into which the cleaning nozzle can be displaced to assume a self-cleaning position in which it can be self-cleaned via pressure-charged supply of cleaning agent; and an unprotected section into which the cleaning nozzle can be displaced to assume a spraying position in which it is provided for spraying of the printer with cleaning agent.

The disclosure also relates to a printing system, such as an inkjet printing system. In an exemplary embodiment, the printing system includes: a printer for printing to a recording medium; and a cleaner according to the disclosure that is provided for cleaning the printer, in particular according to a method according to the disclosure.

In an exemplary embodiment, a nozzle face of a print head provided in a printer is pre-treated with a cleaning fluid before the wiping, in particular before the purging. This advantageously releases possible residues and thus improves the cleaning result. In an exemplary embodiment, the pre-treatment is very targeted, gentle and positionally accurate. For example, the pre-treatment can be exclusively at the nozzle faces of the print heads to avoid unwanted formation of droplets of the cleaning fluid.

In an exemplary embodiment, a regular self-cleaning of the cleaning nozzles is provided that ensures a highly precise pre-treatment of the spraying of the cleaner. In this way, via spraying with cleaning fluid it is prevented that possible deposits on the cleaning nozzles negatively affect the accuracy of the pre-treatment of the nozzle faces. In particular, an effect on the spray cone of the cleaning nozzle, which is very precisely adjusted to avoid droplet formation, is avoided.

In an exemplary embodiment, the self-cleaning may in particular be performed immediately in advance of a pre-treatment cycle or of a spraying of the printer with cleaning fluid. In this way, a direct startup of the cleaning nozzle in the desired manner, in particular with the desired spray cone, is advantageously achieved.

The pre-treatment via spraying of the printer then provides for a release or a kind of soaking of possible ink residues at the nozzle face of a print head. Given an inkjet printing system, after the spraying, the cleaning process also includes what is known as a purging, meaning a strong output of ink or shooting through the print head. What is known as wiping is subsequently performed, meaning wiping off the nozzle face with a wiping lip.

In an exemplary embodiment, a printer includes multiple print bars which respectively have one or more print heads. In one or more exemplary embodiments, a “printer” is a “printing unit” as would be understood by one of ordinary skill in the relevant arts, including of printing systems such as inkjet printing systems.

In an exemplary embodiment, a cleaner includes a number of cleaning pans corresponding to the number of print bars. Each cleaning pan also has at least its own displaceable cleaning nozzle.

In an exemplary embodiment, the cleaning nozzle is configured to be displaceable or capable of travel along the printer, in particular along the print bar of the printer that is to be cleaned. All nozzle faces of the print heads that are to be cleaned in a cleaning pass are thus to be reachable with cleaning agent for spraying.

A number of cleaning nozzles, in particular per cleaning pan, may represent a singleton or a plurality. In an exemplary embodiment, the number is adapted to a number and/or arrangement of the print heads, in particular to a print bar. For example, in the event of a two-row arrangement of print heads at a print bar, two cleaning nozzles or a respective cleaning nozzle for each row may be provided.

In an exemplary embodiment, the method may be implemented at multiple print bars of a printer simultaneously, in particular with a number of cleaning pans of the cleaner corresponding to a number of print bars. Alternatively, however, a sequential cleaning of multiple print bars in succession or a cleaning of only one print bar would also be conceivable.

As would be appreciated by those skilled in the art, aspects and developments can be combined with one another based on the teaching herein. Further, features of the method for cleaning of a printer of a printing system can be transferred to a cleaner and/or a corresponding printing system, and vice versa.

Additional possible embodiments, developments and implementations of the disclosure also encompass combinations that are not explicitly cited of features of the disclosure described previously or in the following with regard to exemplary embodiments. In particular, the person skilled in the art will thereby also add individual aspects as improvements or additions to the respective basic form of the present disclosure.

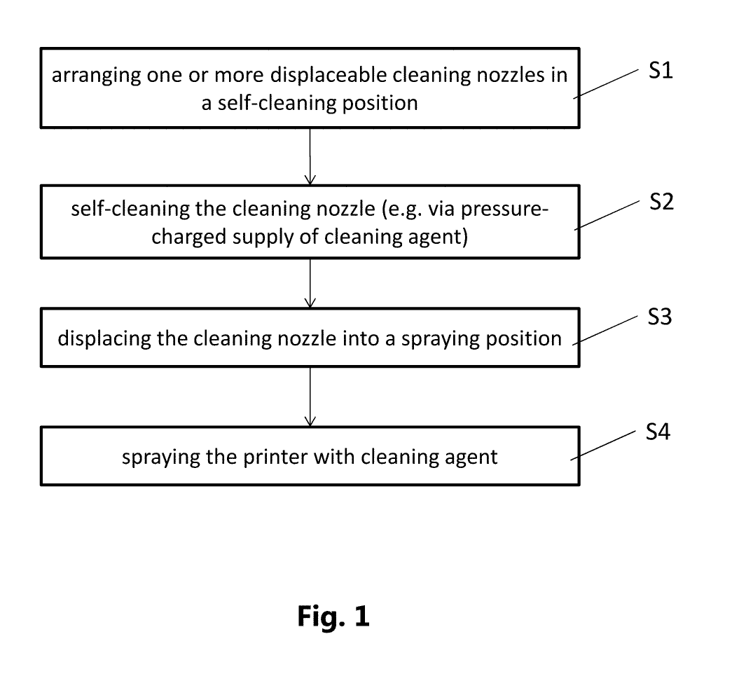

FIG. 1 shows a flowchart of a method according to an exemplary embodiment of the present disclosure.

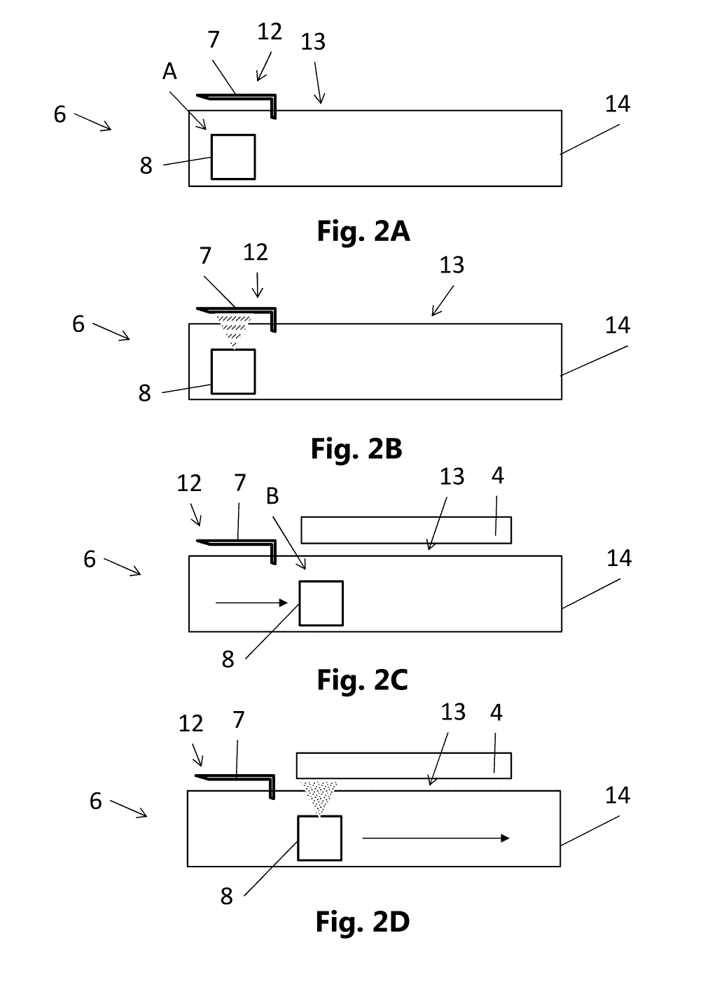

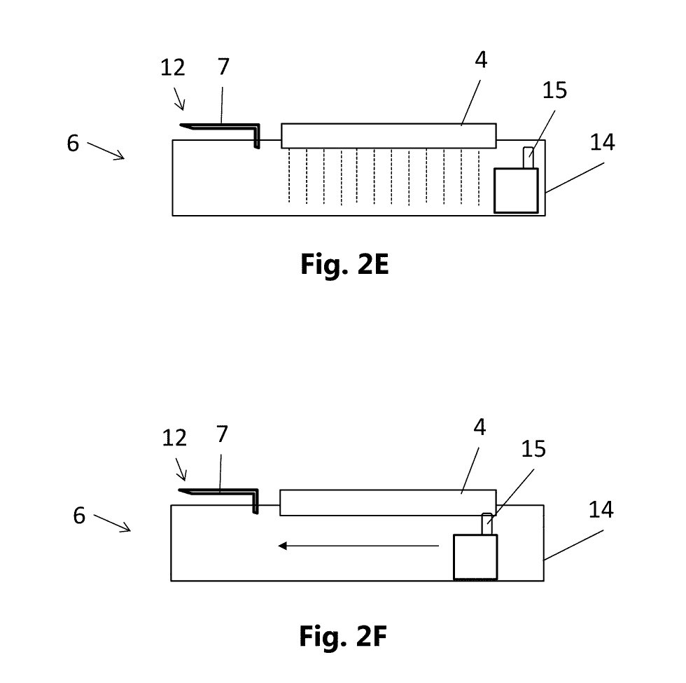

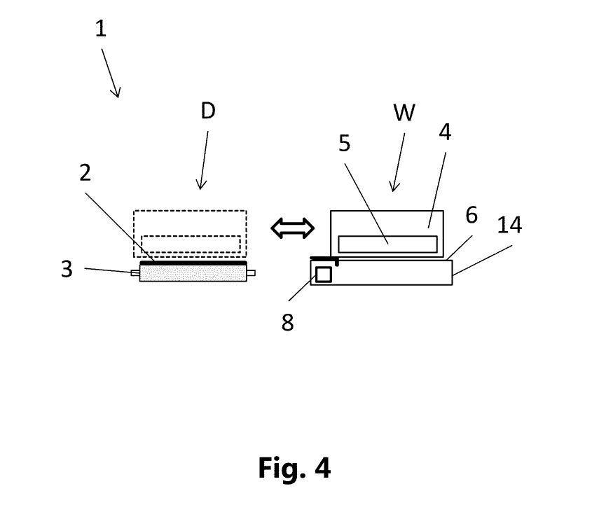

The method serves to clean a printer 4 of an inkjet printing system 1 (see FIG. 4) and first includes the step of arranging S1 one or more displaceable cleaning nozzles 8 in a self-cleaning position A; see in this regard FIG. 2A.

Following this is provided a step of self-cleaning S2 of the cleaning nozzle 8 via pressure-charged supply of cleaning agent; see in this regard FIG. 2B.

A step of the displacement S3 of the cleaning nozzle 8 into a spraying position B for spraying the printer is also provided, as depicted in FIG. 2C.

Finally, the method includes a step of spraying S4 the printer 4 with cleaning agent; see FIG. 2D.

FIG. 2A-2D show the various states of a cleaner according to an exemplary embodiment in the progression of a method according to FIG. 1.

In an exemplary embodiment, the cleaner 6 is configured to automatically clean a printer 4 of an inkjet printing system 1 (see in this regard FIG. 4). In an exemplary embodiment, the cleaner includes a displaceable cleaning nozzle 8 configured to clean the printer 4. In an exemplary embodiment, the cleaner 6 includes processor circuitry that is configured to perform one or more functions and/or operations of the cleaner 6. In an exemplary embodiment, the cleaner 6 includes one or more circuits configured to perform one or more functions and/or operations of the cleaner 6.

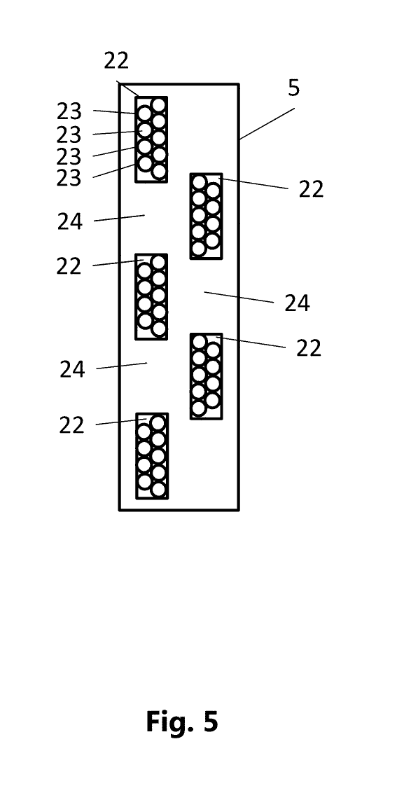

In an exemplary embodiment, the cleaning nozzle 8 is configured to realize a controlled and positionally accurate wetting of the printer 4 via the spraying S4. In an exemplary embodiment, only the nozzle faces of the individual print heads 22 of the printer 4 that are to be cleaned are wetted as precisely as possible, and intervening spaces 24 situated between them remain unwetted; see in this regard FIG. 5.

In an exemplary embodiment, the cleaning nozzle 8 is directed into a cleaning pan 14. In particular, for this a linear guide (not shown here for better clarity) may be provided which guides the cleaning nozzle 8 parallel to a print bar 5 of the printer 4.

In an exemplary embodiment, the cleaner 6 has a protected section 12 into which the cleaning nozzle 8 can be displaced to assume a self-cleaning position A. The protected section 12 has a protective covering 7 which, upon self-cleaning, retains cleaning fluid discharged from the cleaning nozzle 8, as shown in FIG. 2B. Accordingly, the cleaning nozzle 8 is arranged under the protective covering 7 for arrangement S1 in the self-cleaning position A.

In an exemplary embodiment, the self-cleaning position A may, in particular simultaneously represent a park position of the cleaning nozzle 8 in which they are parked by default as long as no cleaning is performed.

In an exemplary embodiment, the cleaning nozzle 8 in the self-cleaning position A may also be subjected to a self-cleaning step S2 via pressure-charged supply of cleaning agent. The protected section 12 of the cleaner 6 is partitioned from the remainder of the printing system 1 by the protective covering 7 so that the self-cleaning may occur without affecting the remaining printing system 1. In an exemplary embodiment, a release of deposits from the cleaning nozzle 8 is therefore also possible via pressure surges, without cleaning fluid arriving into the remaining printing system 1, in particular at the printer 4 to be cleaned. Overall, an uncontrolled exit of cleaning agent is thus prevented.

According to the disclosure, a manual cleaning of the cleaning nozzles is thus advantageously no longer necessary. Instead of this, the cleaning nozzles are always operationally ready due to regular self-cleaning, meaning that they are maintenance-free. Via the self-cleaning S2, it is prevented that possible deposits of content substances of the cleaning agent reduce the nozzle cross section, clog the cleaning nozzles 23, or affect the spray cone in an unwanted manner at inner surfaces of the cleaning nozzles 23 upon the spraying of the printer 4. Instead of this, possible deposits of cleaning agent are discharged in the self-cleaning S2. A problem-free functionality of the cleaning nozzles 8 is always ensured in this way, such that a controlled and positionally accurate wetting of the printer 4 in the desired manner is ensured by the spraying 4, in particular directly following the self-cleaning S2.

In an exemplary embodiment, the cleaner 6 also has an unprotected section 13 into which the cleaning nozzle 8 can be displaced to assume a spraying position B in which it is provided to spray S4 the printer with cleaning agent. The displacement S3 of the cleaning nozzle 8 into the spraying position B to spray the printer 4 thus includes a displacement (shown in FIG. 2C) of the cleaning nozzle 8 out of the protected section 12, into the unprotected section 13.

In the spraying position B, the step of spraying S4 the printer 4 with cleaning agent that is depicted in FIG. 2D then starts. In the shown embodiment, for this the cleaning nozzle 8 is activated in an initial spraying position B and displaced parallel to the printer 4 during the spraying in order to spray the printer 4, or a print bar 5 of the printer 4, over the entire length. For example, the printing nozzle 8 is directed parallel to a print bar 5 along a linear guide.

In an exemplary embodiment, the cleaner 4 may have a plurality of cleaning nozzles 8 which can be displaced and self-cleaned jointly or independently of one another into the protected region 12, and can be displaced into the unprotected section 13 and activated and/or shifted as necessary for spraying of the printer 4.

FIG. 2E shows a cleaning step of what is known as purging.

It is hereby a cleaning step following the method according to FIG. 1, in which cleaning step the print nozzles 23 of the printer 4 that are to be cleaned, or the print heads of the printer 4 that are to be cleaned, are temporarily activated with a high (e.g. maximum) ink discharge. The print nozzles are flushed through, which serves to clean the print nozzles, in particular to free them of deposits.

FIG. 2F shows a cleaning step of what is known as wiping.

It is hereby a cleaning step following the purging according to FIG. 2E, in which cleaning step the surface of the printer 4 is wiped off, in particular the nozzle surfaces of the print heads 22 to be cleaned with a wiping lip 15.

For this, in the shown embodiment the wiping lip 15 is likewise displaced parallel to the printer 4 along a linear guide (not shown), in particular along the linear guide provided for the cleaning nozzle 8. The wiping lip 15 thereby completely wipes off the surface of the printer 4, in particular the nozzle faces of the print heads 22 to be cleaned, in the region to be cleaned with a linear motion.

In an exemplary embodiment, the method according to FIG. 1, or the preceding pre-treatment steps presented in FIGS. 2A through 2D, lead to the situation that ink residues that have possibly dried or deposited on the nozzle faces are in the meantime released or weakened, and thus are easy to remove via the wiping or wiping off with the wiping lip 15. A lower contact pressure of the wiping lip is accordingly sufficient.

A complete and gentle cleaning of the printer 4 is thus advantageously enabled, which overall reduces the necessary frequency of cleaning cycles. In this way, on the one hand the overall mechanical stress of the normally coated surface of the nozzle face may be reduced, and thus the wear may be decreased. Downtimes of a printing system that are also necessary for the cleaning cycles are thus advantageously further reduced.

In an exemplary embodiment, the wiping lip 15 may likewise be subsequently shifted into the protected section 12, and there be subjected to a cleaning procedure, in particular a wet cleaning with cleaning agent. In this way, the functionality of the wiping lip 15 remains ensured in the long term.

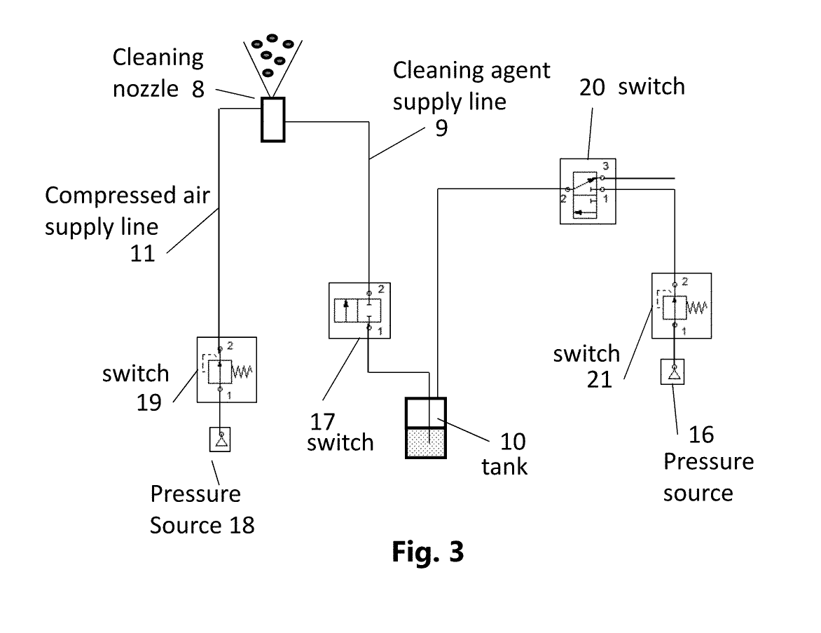

FIG. 3 shows a schematic connection diagram of a fluid system of a cleaner 6 according to an exemplary embodiment.

In an exemplary embodiment, the cleaning nozzle 8 is configured as a two-substance nozzle and accordingly has a cleaning agent supply line 9 and a compressed air supply line 11. Arranged in the cleaning agent supply line 9 is a tank 10 that can be charged with pressure, into which tank 10 cleaning agent is supplied from an external source and be stored temporarily for further use at the cleaning nozzle 8. In an exemplary embodiment, the transfer to the cleaning nozzle 8 is controlled by a switch (e.g. valve 17).

In an exemplary embodiment, the self-cleaning of the cleaning nozzle 8 is configured to free deposits from the inside of the nozzle via pressure surges. In this example, an effective self-cleaning is advantageously ensured. The pressure surges are transmitted by the cleaning fluid. Alternatively or additionally, however, it would also be conceivable to provide pressure surges via a pulsed supply of compressed air.

In an exemplary embodiment, a pressure surge is a brief pressure surge, for example for a duration in a range between 50 ms and 500 ms, in particular between 50 ms and 100 ms, but is not limited thereto.

In an exemplary embodiment, for self-cleaning of the cleaning nozzle 8, multiple pressure surges are applied in succession.

In an exemplary embodiment, a different pressure source and/or a different pressure-charged medium than is used for spraying S4 may be used for self-cleaning S2. As an example, a pressure source 16 charging the tank 10 arranged in the cleaning agent supply line 9 with pressure may be used for self-cleaning S2 instead of the pressure source 18 supplying the compressed air supply line 11, such that the pressure is transferred via the cleaning agent instead of via the compressed air. However, it is also conceivable to operate the same pressure source, in particular the thrust shaft 16 charging the tank with pressure, with respective different pressures for self-cleaning S2 and for spraying S4. In this instance, the compressed air may possibly be additionally connected to atomize the cleaning agent.

However, the same pressure source may also be used, at least temporarily, for self-cleaning and spraying at the same pressure. For example, pressure surges may also be applied, at least temporarily or additionally, via the pressure source 18 with compressed air supplied via the compressed air supply line 11, for example to initially free a possible encrustation from the cleaning nozzle 8. It is likewise conceivable to always charge the tank for spraying S4 with a lower, controlled pressure in order to thus dose a delivery of the cleaning nozzle 8.

In the depicted embodiment, a tank 10 having a first regulated pump 16, said tank being arranged in the cleaning agent supply line 9, is charged with pressure for self-cleaning S2 of the cleaning nozzle 8; see in this regard FIG. 2B. Naturally, however, a different type of pressure supply of the tank 10 is also possible.

In an exemplary embodiment, starting from the tank 10, the pressure-charged cleaning agent for self-cleaning S2 is transferred to the cleaning nozzle 8. In an exemplary embodiment, pressure surges are accordingly controlled by short-term opening and closing of an on/off valve 17 arranged in the cleaning agent supply line 9. The transfer is thus advantageously able to react quickly and possible with a high flow rate. An on/off valve 19 provided at the compressed air supply line 11 is thereby closed.

In an exemplary embodiment, for spraying S4 the printer (see in this regard FIG. 2D), the cleaning nozzle 8 is supplied via the compressed air supply line 11 with compressed air which atomizes the cleaning agent. The cleaning nozzle 8, provided as a two-substance nozzle, is thereby supplied via both the cleaning agent supply line 9 and via an additional compressed air supply line 11. A desired spray cone may be set via a pressure regulation via the regulated pumps 16 and 18.

In an exemplary embodiment, for spraying S4 the printer 4, the tank 10 is provided unpressurized, or only slightly charged with pressure, in particular to less than in the self-cleaning S2. In this way, the operating states of the self-cleaning S2 and the spraying S4 can be switched between via a corresponding, need-based change to the pressure charging of the tank 10.

In an exemplary embodiment, an equalizer valve 20 is provided for unpressurized switching of the tank 10. The equalizer valve 20 may enable a pressure equalization of the tank 10 with the environment in a rest position. In this instance, for spraying S4 of the printer 4 the cleaning agent is drawn out of the tank via the compressed air supplied via the compressed air supply line 11 for atomization, in particular via pulsed exchange as given a jet pump (jet ejector pump).

In comparison to a mere print nozzle or single-substance nozzle, a markedly smaller droplet size at lower exit velocity and a much more accurately positioned spray cone can be realized with a cleaning nozzle 8 designed as a two-substance nozzle. The printer 4—in particular a nozzle face of a print head 22, as shown in FIG. 5—may advantageously thus be wetted by cleaning agent gently and with targeted precision. An unwanted entrance of the cleaning fluid into the print nozzles 23, which might lead to startup difficulties in the resumption of the printing, is thus advantageously avoided. Unwanted droplet formation of the cleaning agent is also avoided.

In an exemplary embodiment, the tank 10 regulated with regard to a cleaning agent level. A predetermined cleaning agent level is thus always maintained, or refilling takes place automatically as needed via an inlet (not shown). This ensures a uniform conveyance of the cleaning fluid by the suction via the compressed air supplied for atomization via the pressure supply line 11, and thus ensures a constant spray cone. In this way, a very fine dosing of the quantity of cleaning agent used for spraying S4 the printer 4 is advantageously enabled, which decreases the cleaning agent consumption and likewise prevents an unwanted droplet formation of the cleaning agent.

In an exemplary embodiment, the cleaning nozzle 8 is also charged via the tank 10 with lower pressure for spraying S4 of the printer 4 than for self-cleaning S2, and the compressed air supply is additionally provided via the compressed air supply line 11. A higher flow rate, and nevertheless a smaller droplet size, can thus be realized if applicable. For example, a feed speed of the cleaning nozzle in the spraying S4 may therefore be increased, and the cleaning process may thus be accelerated.

In an exemplary embodiment, additional auxiliary functions are also possible with the depicted fluid system. In particular, the cleaning agent supply line 9 may be ventilated via the tank 10 charged with pressure given a cleaning agent flow that continues for a predetermined amount of time, in particular at higher flow velocity than given the spraying S4 of the printer 4. Alternatively or additionally, the cleaning agent supply line and/or the tank 10 may also be filled in such a manner, for example upon a cleaning agent exchange or possibly also at a first filling or commissioning of the cleaner.

In an exemplary embodiment, the self-cleaning of the cleaning nozzle 8 includes blowing through with compressed air. This may be provided in various ways. On the one hand, the blowing through may be a pressure surge generated with compressed air. For example, this may be provided for initial loosening of an encrustation of the cleaning nozzles, or possibly also in combination to reinforce a pressure surge applied via the cleaning agent. In an exemplary embodiment, a blowing-through following after the pressure-charged supply of cleaning agent produces a regular operating state for the spraying of the printer. In particular given a two-substance nozzle, if the two-substance nozzle is initially cleaned only with the pressure-charged cleaning fluid for self-cleaning S2, a normally air-filled section is again freed of cleaning fluid. This is particularly advantageous when the spraying S4 of the printer 4 (with prior displacement S3 of the cleaning nozzle 8 into a spraying position B) is performed immediately following the self-cleaning S2. The cleaning nozzle 8 is then ideally prepared for the spraying S4, in particular is cleaned of residues; filled with the cleaning fluid in the regions provided for the cleaning fluid; and free in the regions provided for flow-through with compressed air. In this way, a startup time of the cleaning nozzle 8 to establish the spray cone is minimized, such that the spraying S4 may be performed from the start with the desired discharge, the desired droplet size, and greater position accuracy of the spray cone.

In an exemplary embodiment, a pressure present at the cleaning nozzle 8 for self-cleaning is greater than a pressure present for spraying of the printer 4. A maximum self-cleaning effect may thus be advantageously produced by a strong pressure wave, but a fine atomization at lower exit velocity and higher position accuracy may be achieved for spraying. A high pressure present in the tank 10 for self-cleaning S2 may, for example, be at least 1 bar, 1.4 bar in an embodiment. A pressure present at the cleaning nozzle 8 for spraying may, for example, be less than 1 bar, approximately 0.5 bar in an embodiment.

In an exemplary embodiment, the cleaner 6 has a plurality of cleaning nozzles 8, wherein the cleaning nozzles 8 are charged individually or in groups with pressure surges for self-cleaning, and/or each cleaning nozzle 8 is charged repeatedly with a pressure surge. In this way, a pressure wave may respectively be concentrated on individual cleaning nozzles 8, and the self-cleaning effect thus may be maximized.

In a self-cleaning process according to an exemplary embodiment, the tank 10 is placed under a pressure of, for example, 1.4 bar and the on/off valve 17 to the cleaning nozzle is opened and closed again in short intervals of, for example, approximately 50 ms. Short pressure surges at increased pressure (e.g. 1.4 bar) thereby remedy a possible clog/adhesions in the cleaning nozzle 8. The air supply of the cleaning nozzle 8 via the compressed air supply line 11 is thereby deactivated. Given multiple cleaning nozzles 8, the respective on/off valves to the cleaning nozzles are accordingly opened and closed again individually for each cleaning nozzle or in “cleaning nozzle groups”. In an exemplary embodiment, printer and/or printing system includes a controller that is configured to control the operation of one or more of the valves 17, 19, 20 and 21. In an exemplary embodiment, the controller(s) includes one or more circuits configured to control the valves 17-21. In an exemplary embodiment, the controller(s) includes processor circuitry configured to control the valves 17-21.

In an exemplary embodiment, to ventilate the cleaning agent supply line 9, the tank 10 is likewise placed under pressure and the on/off valves 17, 19 and 21 remain open for multiple minutes. The cleaning nozzle is thereby located in the self-cleaning position A according to FIG. 2B. At the flow velocity in the cleaning agent supply line 9, which flow velocity is increased by the pressure in the tank 10, air bubbles or surfactant bubbles in couplings, conduits and valves are remedied.

In an exemplary embodiment, the procedure for changing the cleaning fluid proceeds similarly. The ventilation process may therefore likewise be used to exchange the cleaning fluid for a different or new cleaning fluid.

In an exemplary embodiment, after each cleaning, ventilation, or cleaning fluid exchange, the cleaning nozzle 8 is briefly blown through with compressed air from the compressed air supply line 11, as in the regular operating state upon spraying S4. Residual fluids from the compressed air region are remedied with the compressed air. The blowing-through may also be activated at intervals in the fluid exchange or upon ventilation to remedy air bubbles and/or surfactant bubbles.

FIG. 4 shows a schematic depiction of a section of a printing system 1 according to an exemplary embodiment.

The inkjet printing system 1 includes a printer 4 configured to print to a recording medium 2, and a guidance device 3 to guide or convey the recording medium 2.

In an exemplary embodiment, the printer 4 comprises multiple print bars 5. A print bar 5 is thereby respectively provided per color to be printed, for example four print bars arranged in succession in a four-color system. In an exemplary embodiment, the print bar 5 is respectively cleaned at its own cleaning pan 14 of a cleaner 6. In the shown perspective, the additional print bars as well as the additional cleaning pans 14 are occluded.

In an exemplary embodiment, each print bar 5 has one or more print heads 22, depending on the width of a recording medium 2 to be printed to or depending on the design of the printing system 1.

In an exemplary embodiment, in a printing position D, depicted here with dashed lines, the printer 4 is arranged on the recording medium 2. However, the printer 4 is designed so that it can be shifted into a service position W (depicted with solid lines) in which it can be cleaned by the cleaner 6 on its nozzle face side, as is described with regard to preceding FIGS. 1 to 3.

In an exemplary embodiment, a number of cleaning nozzles 8 of the cleaner 6 may in particular conform to the number and/or arrangement of the print heads 22 of a print bar 5.

FIG. 5 shows a schematic depiction of a print bar 5 of a printer 4 according to an exemplary embodiment.

In an exemplary embodiment, the print bar 5 has—purely as an example—five print heads 22. Each print head 22 has a plurality of print nozzles 23 provided at a nozzle face, which print nozzles 23 here are schematically depicted with nine circles, respectively. Such print nozzles 23 at each print head actually involve a much larger number, in particular hundreds or thousands, and nozzles of very small dimensions, in particular in the micrometer range.

As an example, the print heads 22 are arranged in two parallel rows offset from one another. In this way, a width of a recording medium 2 corresponding to the length of the depicted print bar 5 can be completely printed to with the respective color without manipulation of the printer. Other arrangements of the print heads of a print bar, for example in one row, are naturally possible.

Corresponding to the two rows, two cleaning nozzles 8 arranged next to one another are provide in a cleaner 6 provided to clean the print bar 5, wherein a respective cleaning nozzle 8 is aligned toward a row. The cleaning nozzles 8 may in particular be guided along a common linear guide, parallel to the print bar 5. In an exemplary embodiment, the associated cleaning nozzle 8 is respectively activated only in a region of a print head 22 for spraying S4 of the printer 4.

In an exemplary embodiment, immediately before the spraying S4, a self-cleaning S2 of the cleaning nozzles 8 is implemented (see FIG. 2B) so that a spray cone for spraying S4 (see FIG. 2D) has a high precision. In this way, a very differentiated spraying of the print bar 2 is enabled with high precision, in particular only in the region of the print heads 22.

Although the present disclosure has been described in the preceding entirely using exemplary embodiments, it is not limited to these, but rather can be modified in diverse ways.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” includes one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. When the instructions are executed by the processor, the processor performs the corresponding function(s) associated with the processor, and/or one or more functions and/or operations related to the operation of a component having the processor included therein. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

1 printing system
2 recording medium
3 guidance device
4 printer
5 print bar
6 cleaner
7 protective covering
8 cleaning nozzle
9 cleaning agent supply line
10 tank
11 compressed air supply line
12 protected section
13 unprotected section
14 cleaning pan
15 wiping lip
16 pressure source
17 on/off valve
18 pressure source
19 on/off valve
20 equalization valve
21 on/off valve
22 print head
23 print nozzle
24 intervening space
A self-cleaning position
B spraying position
D printing position
W service position
S1-S4 operations/steps

1. A method for cleaning a printer of a printing system, comprising:
arranging at least one displaceable cleaning nozzle in a self-cleaning position;
supplying a pressure-charged cleaning agent to self-clean the cleaning nozzle;
displacing the cleaning nozzle into a spraying position for spraying the printer; and
spraying the printer with cleaning agent.

2. The method according to claim 1, wherein the cleaning nozzle is arranged under a protective covering in the self-cleaning position.

3. The method according to claim 1, wherein the self-cleaning of the cleaning nozzle comprises freeing deposits via pressure surges.

4. The method according to claim 1, wherein the supplying a pressure-charged cleaning agent comprises:
charging a tank arranged in the cleaning agent supply line with pressure for self-cleaning, and
transferring the pressure-charged cleaning agent to the cleaning nozzle based on the charging the tank with pressure.

5. The method according to claim 4, further comprising:
ventilating the cleaning agent supply line; or
filling the cleaning agent supply line by a cleaning agent flow that is continuous for a predetermined period of time via the tank charged with pressure.

6. The method according to claim 5, wherein:
the ventilating the cleaning agent supply line is at a higher flow velocity than the spraying of the printer; and
the filling the cleaning agent supply line is at a higher flow velocity than the spraying of the printer

7. The method according to claim 4, wherein supplying the pressure-charged cleaning agent comprising atomizing the cleaning agent with compressed air and supplying the atomized cleaning agent to the cleaning nozzle for spraying of the printer.

8. The method according to claim 7, wherein the tank is provided unpressurized or charged to low pressure, and, for spraying of the printer, the cleaning agent is drawn from the tank by the compressed air supplied for atomizing the cleaning agent.

9. The method according to claim 7, wherein the self-cleaning of the cleaning nozzle further comprises blowing compressed air through the cleaning nozzle after the supply of the pressure-charged cleaning agent to produce a regular operating state for the spraying of the printer.

10. The method according to claim 1, wherein a pressure present at the cleaning nozzle for self-cleaning is provided higher than a pressure present for spraying of the printer.

11. The method according to claim 1, wherein the cleaner comprises a plurality of cleaning nozzles that are charged with pressure surges individually or in groups to self-clean the plurality of cleaning nozzles, and/or each cleaning nozzle of the plurality of cleaning nozzles is charged repeatedly with a pressure surge to self-clean the plurality of cleaning nozzles.

12. The method according to claim 1, wherein the printing system is an inkjet printing system.

13. A non-transitory computer-readable storage medium with an executable program stored thereon, that when executed, causes a processor to perform the method of claim 1.

14. A cleaner adapted to automatic clean a printer of a printing system, comprising:
a displaceable cleaning nozzle;
a protected section configured to accept the cleaning nozzle into which the cleaning nozzle assumes a self-cleaning position, the cleaner being configured to self-clean the cleaning nozzle by a pressure-charged supply of cleaning agent in the self-cleaning position; and
an unprotected section configured to accept the cleaning nozzle into which the cleaning nozzle assumes a spraying position, the cleaner being configured to spray the printer with cleaning agent in the spraying position.

15. The cleaner according to claim 14, wherein the protected section comprises a protective covering configured to retain cleaning fluid discharged from the cleaning nozzle in the self-cleaning position.

16. The cleaner according to claim 14, further comprising a tank configured to be charged with pressure for self-cleaning of the cleaning nozzle, the tank being provided in a cleaning agent supply line of the cleaning nozzle.

17. The cleaner according to claim 16, further comprising one or more switches configured to control pressure surges to be transferred from the tank to the cleaning nozzle.

18. A printing system comprising:
a printer configured to print to a recording medium, and
a cleaner according to claim 14, the cleaner being configured to clean the printer.
